(19) United States
(12) Patent Application Publication
(10) Pub. No.: US 2009/0177733 A1
(43) Pub. Date: Jul. 9, 2009

(54) Client application localization

(76) Inventor: Albert Talker, Marlboro, NJ (US)

Correspondence Address: Albert Talker, 17 Memorial Rd, Marlboro, NJ, 07746, US

(21) Appl. No.: 12/006,916

(22) Filed: Jan. 8, 2008

(51) Int. Cl. G06F 15/16

(52) U.S. Cl. 709/203

(57) ABSTRACT

A method for application localization support on Web applications includes retrieving a locale database from a server, translating text strings using the locale database and optionally a locale electronic translation dictionary, and formatting text strings using format strings retrieved from the locale database. The method also includes the extraction of localized resources as prompt statements and localized images from the database and providing the resources to the application. After defining localization parameters and localized data and storing the parameters and data in a database, support for new localization, or modification and maintenance of existing localization, may be done through adding or manipulating of the data in the database.

### BACKGROUND OF THE INVENTION

1. Technical Field

The present invention is directed to an improved method and system for providing localization information in web based applications. Still, more particularly, the present invention relates to an improved method and system for dynamically updating Web browser's localization content based on a locale data stored in the client.

2. Description of the Related Art

Software products have obtained a global marketplace. To obtain an international presence, software programs must be modified to fit the foreign market. Internationalization is the process of removing language and cultural dependencies from a software application. How well a developer internationalizes its application may become the single biggest factor in determining the success or failure of an organization's products overseas.

Web content providers currently face several problems related to internationalization. Most of these issues revolve around providing sufficient and accurate localization to their web content. End users expect web content to be presented in a manner appropriate for their language and cultural norms. These include the presentation of monetary quantities, numeric quantities, dates, time, and the like. These issues are only compounded by the lack of localization support in Web browsers. Web browsers' currently only address the display of text. They do not provide support for providing dynamic localization. This is a huge problem affecting content providers that wish to support the multinational marketplace. To work around these problems, content providers must create specific solutions for each country and language.

Language and culture drive certain behavior in many different programs. In addition to the text strings, language and cultural considerations can affect many other aspects of a program, and specifically functional aspects of the program. These functional aspects of a program have generally been ‘hard coded’ into the source code and been notoriously difficult to update and change. Adding support for a new language or culture can be especially difficult when the program has many culture-specific functions.

It would therefore be advantageous to provide a system and method for maintaining and adding cultural support for computer applications deployed in several different cultures.

Therefore, a need exists for dynamically updating a Web browser's localization content based on a locale database stored in the client sent by a server on demand from client's computers. The subject invention herein, solves this problem in a unique and novel manner not previously known in the art.

### SUMMARY OF THE INVENTION

The method and system of the present invention updates a Web browser's localization content using a locale database sent by the server and used to display content onto the Web browser. Additionally, the Web browser can use locale dictionary stored in the client or somewhere in a central location in the network. The Web browser translates and formats content based on information stored in the locale database, and then sends locale event message and localization information content to a server if the content cannot be translated or formatted. The server will update its locale database and associated formatting parameters and then sends updates to the locale database on the client. The Web browser then formats and delivers an HTML for display on the client based on the localization information content.

The above as well as additional objects, features, and advantages of the present invention will become apparent in the following detailed written description.

### BRIEF DESCRIPTION OF THE DRAWINGS

The novel features believed characteristic of the invention are set forth in the appended claims. The invention itself however, as well as a preferred mode of use, further objects and advantages thereof, will best be understood by reference to the following detailed description of an illustrative embodiment when read in conjunction with the accompanying drawings, wherein:

FIG. 1 is an exemplary block diagram illustrating an example system for application localization according to one embodiment of this disclosure;

FIG. 2 is an exemplary block diagram illustrating an example of data flow supporting application localization showing the method of allowing Web browsers to dynamically change their localization information according to one embodiment of this disclosure;

FIG. 3 is an exemplary block diagram illustrating an example system for application localization according to one embodiment of this disclosure wherein no local translation dictionary is used;

FIG. 4 is an exemplary block diagram illustrating an example system for application localization according to one embodiment of this disclosure wherein the locale database is stored centrally in a computer network and shared with other computers;

FIG. 5 is an exemplary block diagram illustrating an example of data flow supporting application localization showing the method of allowing Web browsers to dynamically change their localization information with a use of an electronic translation dictionary and a Locale database stored in a central location accessible by all clients;

### DESCRIPTION OF THE PREFERRED EMBODIMENT

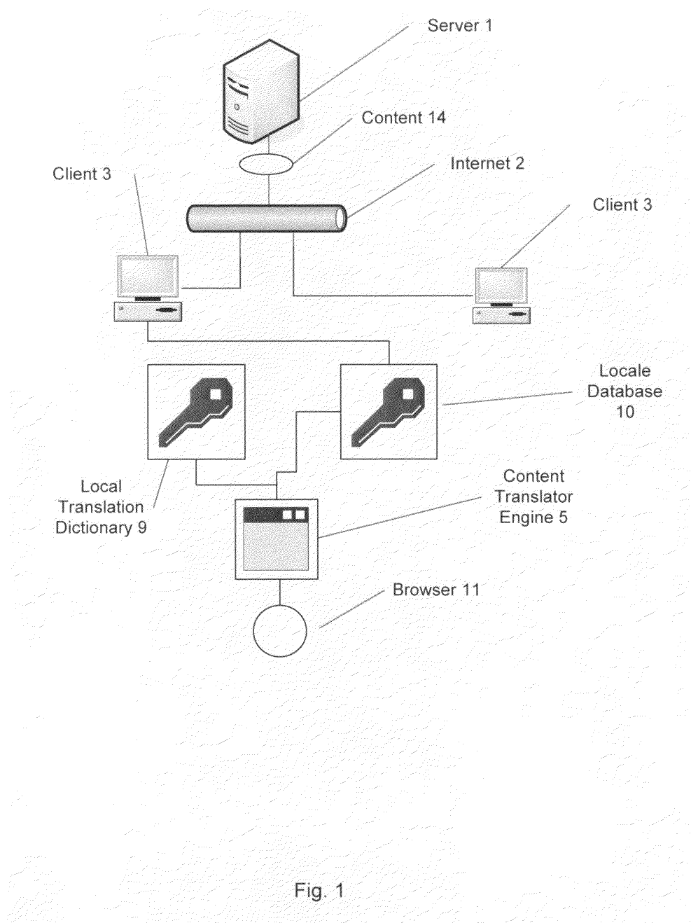

In the illustrated embodiment, with references to the figures, and in particular with reference to FIG. 1, server 1 is coupled to Internet network 2. In this specification, the term “couple” refers to any direct or indirect communication between two or more components, whether or not those components are in physical contact with one another. Also, the term “communication” refers to communication between physically separate components or between components within a single physical unit. Server 1 performs one or more functions to provide services to client 3. For example, server 1 could execute one or more web applications on behalf of one or more clients 3. Server 1 may include any hardware, software, firmware, or combination thereof operable to provide services to one or more clients 3.

Internet Network 2 is coupled to server 1 and client 3. Internet Network 2 facilitates communication between components of the system. For example, Internet Network 2 may communicate Internet Protocol (IP) packets, frame relay frames, Asynchronous Transfer Mode (ATM) cells, or other suitable information between Internet Network addresses. Internet Network 2 may include one or more local area networks (LANs), metropolitan area networks (MANs), wide area networks (WANs), or any other communication system or systems at one or more locations.

Client 3 is coupled to Internet Network 2. Client 3 could include a Web browser, a client application, or other suitable application or logic for communicating with server 1. Client 3 may retrieves Content 14 (HTML-formatted data) from Server 1 and uses browser 11 to display such information. Client 3 may also execute programs in the Content Translator Engine 5 in connection with such retrieval and/or display. The Content Translator Engine 5 expands the currently defined notion of a locale by encapsulating localization information onto the Web browser 11, thereby enabling the Web browser 11 to be internationalized. The Content Translator Engine 5 extends the Web Browser to allow for different cultural attributes, such as, for example, language, date, time, currency, etc.

The language used to implement The Content Translator Engine 5 may be for example C++ or Java which uses the concepts of software programming. Also, other programming languages may be used in accordance with the teachings of the present invention. The Content Translator Engine 5 is coupled with the Web browser 11 and causes the Web browser 11 to change its localization information dynamically. By enabling this technology the server produces same content 14 to all the Clients 3 and the Content Translator Engine 5 coupled with browser 11 will generate HTML pages with correct localization information from the client on the fly.

It should be appreciated that the present invention updates a Web browser's localization content in response to receiving a locale database 10 from the server 1. After the server sends locale database 10 containing client localization information, the Content Translator Engine 5 coupled with the Web browser updates its locale information and reformats all its localization information content. The locale database 10 may be stored within the Web browser 11 and kept on the client 3 for a defined time period. In another embodiment of the main embodiment, the locale database 10 may be stored in a central location accessible by all clients 3.

When specific parts of the content received from server 1 cannot be localized (translated or formatted), the Web browser coupled with the Content Translator Engine 5 sends an error event message together with the information content 14 that cannot be localized to the server. The server updates its locale information and associated server side translation strings and then the server delivers an update to the locale database 10.

The Content Translator Engine 5, upon receiving content from Server 1 will translate all content needed to be translated. A Local Translation Dictionary 9 stored on the client can be used for translation of content. The Locale Database 10 then will be used to translate specific string content which cannot be translated using the Local Translation Dictionary 9. The Locale Database 10 will also be used with specific localization information which needs locale formatting. The specific localization information will be formatted based on formatting information contained in the locale database 10. Examples of such formatting include:
1. “Day,” which is a string containing the name of a day given a particular day of the week.
2. “Month,” which is a string containing the name of a month given a particular month of the year.
3. “Date,” which is a formatted string containing a date is given a particular day, month, and year.
4. “Time,” which is a formatted string, containing a time given hours, minutes, and seconds.
5. “Currency symbol,” which is string containing the international currency identifier for the current locale.
6. “Decimal,” which is a string containing the symbol used to separate fractional quantities from whole quantities from the current locale.
7. “Thousands,” which is a string containing the symbol used to separate multiples of 1,000.
8. “Sign,” which is a string containing the symbol used to represent positive and negative quantities for the current locale.
9. “Fractional quantities,” which is a number representing the number of digits to display after the decimal point in monetary quantities.
10. “Menu,” when a given request for a standard menu bar occurs, translated “Strings” are provided with regard for pre-defined browsers and operating systems.

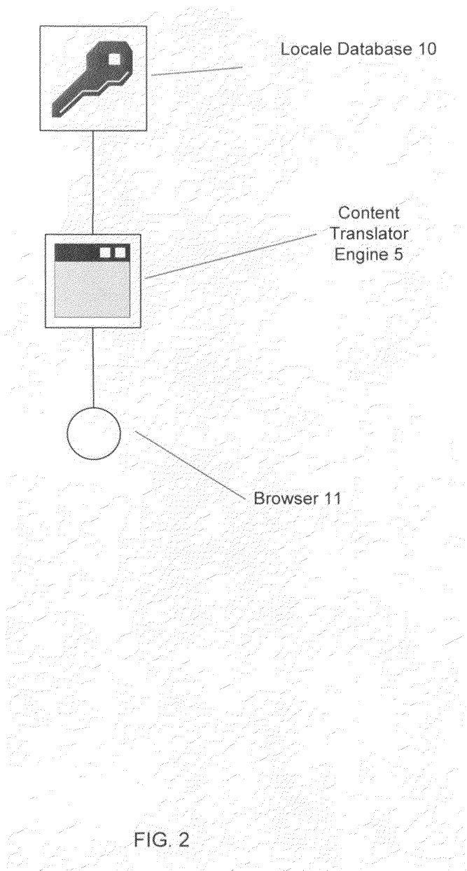

Referring now to FIG. 2, there is depicted a Locale Database 10 sent by the server 1 which resides in the client 3. The Locale Database 10 contains Locale language strings to be interchanged with the language strings of the Content 14 sent by server 1. The Content Translator Engine 5 coupled to the Browser 11 and the Local Database 10, will replace content strings with strings translations stored in the Locale Database. In addition, the Content Translator Engine 5 will extract from the Locale Database 10 the following locale resources based on the content 14 sent from the server 1:
1. Formatting Data
2. Prompt Statements
3. Localized Images
4. Localized Voice Files
5. Localized Video Files
6. Localized Program Code
   Date, time, currency, numeric and other specific content data will need to be formatted based on Locale formatting data. The formatting data and formatting rules are extracted from the Locale Database 10 and then the Content Translator Engine formats the data and presents it to the Browser 11. When the Content 14 sent from the server includes one or more of the following resources:
1. Prompt Statements
2. Localized Images
3. Localized Voice Files
4. Localized Video Files
   The Content Translator Engine 5 will extract the localized resources from the Locale Database 10 and deliver them to the Browser 11.

When the Content 14 sent from the server contains localized code as Java programs, Java Scripts, or VB scripts, then the Content Translator Engine 5 will extract the localized code from the Locale Database 10 and delivers them to the Browser 11. In addition, the Content Translator Engine 5 may directly replace text strings within the program code imbedded in the content as Java or VB scripts.

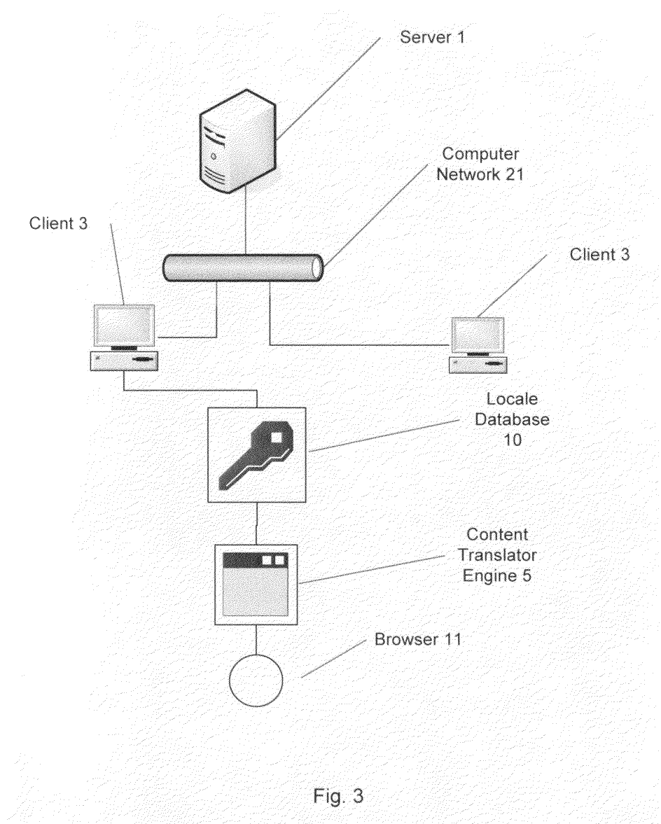

Referring now to FIG. 3, there is depicted the illustrated a version of the main embodiment, with references to the figures, and in particular with reference to FIG. 1, wherein server 1 is coupled to a Computer Network 21. In this embodiment Client 3 is coupled to a Computer Network 21. Client 3 could include a web browser, a client application, or other suitable application or logic for communicating with server 1. Client 3 may retrieve content 14 (HTML-formatted data) from Server 1 and uses browser 11 to display such information. Client 3 may also execute programs in the Content Translator Engine 5 in connection with such retrieval and/or display.

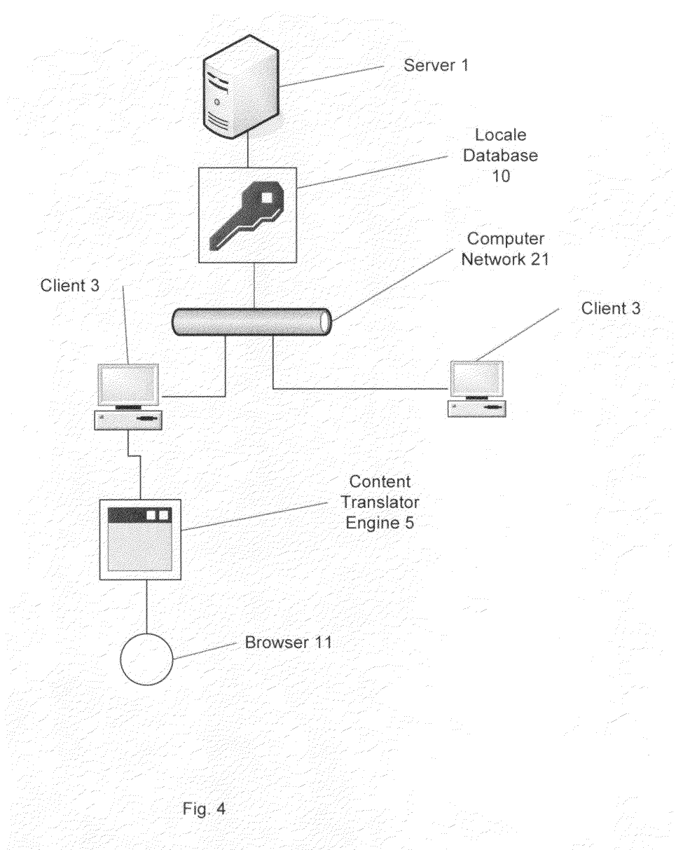

Referring now to FIG. 4, there is depicted the illustrated another version of the main embodiment, with references to the figures, and in particular with reference to FIG. 1 and FIG. 3, wherein server 1 is coupled to a Computer Network 21 and a Locale Database 10 is stored in a central location accessible by all clients. In this embodiment Client 3 is coupled to a Computer Network 21. Client 3 could include a web browser, a client application, or other suitable application or logic for communicating with server 1 and means for extraction of data from locale database 10 stored on a central location in the network. Client 3 may retrieve content 14 (HTML-formatted data) from Server 1 and uses browser 11 to display such information. Client 3 may also execute programs in the Content Translator Engine 5 in connection with such retrieval and/or display. Client 3 may also execute programs in the Content Translator Engine 5 to access the Locale Database 10 stored in an accessible location in the network.

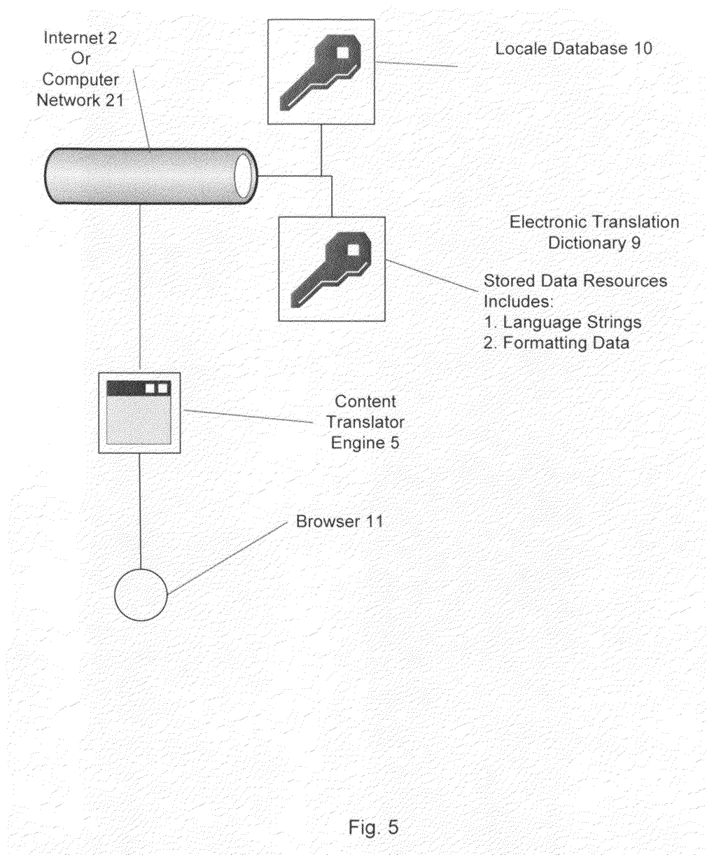

Referring now to FIG. 5, there is depicted a specialized version of the main embodiment, wherein server 1 is coupled to a Computer Network 21 or an Internet Network 2 or both, wherein the Locale Database 10 and the Electronic Translation Dictionary 9 are stored in central locations accessible by all clients in an Internet Network or other Computer Network. In this embodiment Client 3 is coupled to a Computer Network 21 and/or Internet network 2. Client 3 could include a web browser, a client application, or other suitable application or logic for communicating with server 1. The client 3 contains also means for extraction of data from locale database 10 and Electronic Translation dictionary 9 stored on a central location in the network. Client 3 retrieves Content 14 (HTML-formatted data) from Server 1 and uses Browser 11 to display such information. Client 3 also executes programs in the Content Translator Engine 5 in connection with such retrieval and/or display of localized content, and further executes programs for the retrieval of data stored in the Locale Database 10 and an Electronic Translation dictionary 9 located in an accessible location in the network.

It is also important to note that although the present invention has been described in the context of fully providing functional localization support in Web applications, those skilled in the art will appreciate that the mechanisms of the present invention are capable of being distributed as a program product in a variety of forms to any type of information handling system, and that the present invention applies equally regardless of the particular type of signal bearing media utilized to actually carry out the distribution. Examples of signal bearing media include, without limitation, recordable type media such as floppy disk or CD ROMs and transmission type media such as analog or digital communications links.

While the invention has been particularly shown and described with reference to a preferred embodiment, it will be understood by those skilled in the art that various changes in form and detail may be made therein without departing from the spirit and scope of the invention.

While the invention is susceptible to various modifications and alternative forms, specific embodiments of the invention are shown by way of example in the drawings and will herein be described in detail. It should be understood, however, that there is no intent to limit the invention to the particular forms disclosed, but on the contrary, the invention is to cover all modifications, equivalents, and alternatives falling within the spirit and scope of the invention as defined by the claims. In general, the embodiments were selected to highlight specific inventive aspects or features of the invention.

Throughout this specification, like reference numbers signify the same elements throughout the description of the figures.

When elements are referred to as being “connected” or “coupled,” the elements can be directly connected or coupled together or one or more intervening elements may also be present. In contrast, when elements are referred to as being “directly connected” or “directly coupled,” there are no intervening elements present.

The invention may be embodied as devices, systems, methods, and/or computer program products. Accordingly, some or all of the invention may be embodied in hardware and/or in software (including firmware, resident software, micro-code, state machines, gate arrays, etc.) Furthermore, the present invention may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device.

### Client AND Client Computer—

The term “Client” and “Client Computer” as used herein means a system or systems which are able to embody and/or execute the logic of the processes described herein. The logic embodied in the form of software instructions or firmware may be executed on any appropriate hardware which may be a dedicated system or systems, or a general purpose computer system, or distributed processing system, all of which are well understood in the art, and a detailed description of how to make or use such computers is not deemed necessary herein. It should be noted that the Server computer, and Client computer as described herein may be embedded within a single computer or programmed logic system, or be implemented as separate computers or programmed logic systems, or be executed on multiple systems using any of the distributed processing models as are well understood in the art, or be implemented using any mixture of the above.

### Internet (2) or Computer Network (21)

The terms refer to any suitable communication link which permits communications (e.g. Internet, computer network, telephone). It should be understood that the terms are not limited to “Internet” or any other particular system or type of communication link. That is, the terms Internet (2) or Computer Network (21) is intended only to refer to any suitable communication system, including extra-computer system and intra-computer system communications. Examples of such communications systems include internal busses, local area networks, wide area networks, point-to-point shared and dedicated communications, infra-red links, microwave links, telephone links, CATV links, Satellite and radio links and fiber-optic links. The terms Internet (2) or Computer Network (21) can also refer to any suitable communication system for sending messages between remote locations, directly or via a third party communication provider.

What is claimed is:

1. A method for application localization, which contains localization information database, to enable localization support for document display of information content delivered from a server to a client and into its Web browser, said method comprising the steps of:
receiving by said client said locale information database from said server;
receiving by said client said information content from said server;
translating said information content using said locale information database;
retrieving from said locale information database a format string using a string identifier supplied by said information content, the format string defining a format of a text string;
generating the text string using the retrieved format string;
updating document display information within said Web browser in accordance with said translated localization of said information content and said format strings of said information content.

2. The method of claim 1, wherein said updating document display information within said Web browser further comprises the step of:
translating said information content within said Web browser using locale translation dictionary stored on said client;

3. The method of claim 1, wherein said updating document display information within said Web browser further comprises the step of extraction of localized resources including;
(a) prompt statements,
(b) localized images,
(c) voice files,
(d) video files,
(e) program code,
from said locale information database and providing the resources to the said Web browser.

4. The method of claim 1, wherein said updating document display information is followed by the step of:
formatting and delivering an HTML document for display to said client based on said localization information content.

5. The method of claim 1, wherein said updating document display information is followed by the steps of:
sending to the said server locale event message and said information content from said client for which further formatting, resources or translation are needed;
sending to the said server instructions means responsive to receiving said locale event message and said localization information content from said client, for updating locale information database in accordance with said localization information content;
receiving from the said server updates to the said locale information database.

6. A locale specific database downloaded from a server comprising: query mechanisms by which a plurality of executable programs may query said database to receive translated and formatted text strings, a plurality of executable programs to query and extract localized resources including;
(a) prompt statements,
(b) localized images,
(c) voice files,
(d) video files,
(e) program code,
from said locale information database and providing the resources to the said client, and procedures for adding additional values and resources to said database.

7. The database of claim 6 wherein: said values are in a non-human readable format when queried from said database.

8. The database of claim 6 wherein: said values are in a human readable format when queried from said database.

9. The database of claim 6 wherein said procedure comprises the method of: reading raw data; removing at least one duplicate entry; and saving said database in a machine readable form.

10. A system for application localization, which contains localization information database, to enable localization support for document display of information content delivered from a server to a client and into its Web browser, said system comprising:
means for receiving by said client said locale information database from said server;
means for receiving by said client said information content from said server;
means for translating said information content using said locale information database;
means for retrieving from said locale information database a format string using a string identifier supplied by said information content, the format string defining a format of a text string; generating the text string using the retrieved format string;
means for updating document display information within said Web browser in accordance with said translated localization of said information content and said format strings of said information content.

11. The system of claim 10, further comprising:
means for formatting and delivering an HTML document for display to said client based on said localization information content.

12. The system of claim 10, further comprising:
means for updating document display information within said Web browser further comprises means for translating said information content within said Web browser using locale translation dictionary stored on said client.

13. The system of claim 10, further comprising:
Means for updating said document display information within said Web browser further comprises the step of extraction of localized resources including;
(a) prompt statements,
(b) localized images,
(c) voice files,
(d) video files,
(e) program code,
from said locale information database and further comprises of means for providing the resources to the said Web browser.

14. The method of claim 10, further comprising:
means for formatting and delivering an HTML document for display to said client based on said localization information content.

15. A method for application localization, which contains localization information database, to enable localization support for document display of information content delivered from a server to a client and into its Web browser, said method comprising the steps of:
storing locale information database sent from said server in a central location in a computer network;
receiving by said client said information content from said server;
translating said information content using said locale information database stored in a computer network;
retrieving from said locale information database a format string using a string identifier supplied by said information content, the format string defining a format of a text string;
generating the text string using the retrieved format string;
updating document display information within said Web browser in accordance with said translated localization of said information content and said format strings of said information content.

16. The method of claim 15, wherein said updating document display information within said Web browser further comprises the step of:
translating said information content within said Web browser using a locale translation dictionary stored on a central location in a computer network;

17. The method of claim 15, wherein said updating document display information within said Web browser further comprises the step of:
translating said information content within said Web browser using locale translation dictionary stored on said client;

18. The method of claim 15, wherein said updating document display information within said Web browser further comprises the step of extraction of localized resources including;
(a) prompt statements,
(b) localized images,
(c) voice files,
(d) video files,
(e) program code,
from said locale information database and providing the resources to the said Web browser.

19. The method of claim 15, wherein said updating document display information is followed by the step of:
formatting and delivering an HTML document for display to said client based on said localization information content.

20. The method of claim 15, wherein said updating document display information is followed by the steps of:
sending to the said server locale event message and said localization information content from said client for which further formatting, resources or translation are needed;
sending to the said server instructions means responsive to receiving said locale event message and said localization information content from said client, for updating locale information database in accordance with said localization information content;
receiving from the said server updates to the said locale information database.
